(19) United States
(12) Patent Application Publication
(10) Pub. No.: US 2011/0136548 A1
(43) Pub. Date: Jun. 9, 2011

(54) Voice message outputting device

(75) Inventor: Hiroshi Sakai, Okazaki-city (JP)

(73) Assignee: DENSO CORPORATION, Kariya-city (JP)

(21) Appl. No.: 12/925,879

(22) Filed: Nov. 1, 2010

(30) Foreign Application Priority Data
Dec. 3, 2009 (JP) 2009-275803

(51) Int. Cl. H04M 1/00

(52) U.S. Cl. 455/569.2

(57) ABSTRACT

A voice message outputting device includes: a voice message information data obtaining element for obtaining voice message information data that represents a content of a voice message; a number detector for detecting the number of the voice message information data, which is requested to be output simultaneously; a voice message information processor for outputting voice message information annunciation data when the number of the voice message information data is equal to or larger than a predetermined number, the voice message information annunciation data having a message length changed from the voice message information data; and an outputting element for outputting the voice message based on the voice message information annunciation data.

### CROSS REFERENCE TO RELATED APPLICATION

This application is based on Japanese Patent Application No. 2009-275803 filed on Dec. 3, 2009, the disclosure of which is incorporated herein by reference.

### FIELD OF THE INVENTION

The present invention relates to a voice message outputting device mounted on a vehicle for providing information to a passenger of the vehicle.

### BACKGROUND. OF THE INVENTION

Conventionally, when a voice message outputting device informs a massage to a passenger of a vehicle, an informing method is determined based on a vehicle speed. For example, in JP-A-2007-279975 corresponding to US 2009/0112582, an in-vehicle device for providing a voice message function determines a speed of outputting a message based on an emergency degree of the message and the vehicle speed. Then, if necessary, the device emphasizes the voice message so that the device alerts the passenger intuitively.

However, in the above device, when the device informs multiple messages at the same time, the message may be hard to hear since the outputting speed of the message is high. Further, it is required to provide a lot of information in a short period of time so that a driver of the vehicle can focus on operation of the driving.

### SUMMARY OF THE INVENTION

In view of the above-described problem, it is an object of the present disclosure to provide a voice message outputting device mounted on a vehicle for providing information to a passenger of the vehicle in a short period of time.

According to an aspect of the present disclosure, a voice message outputting device mounted on a vehicle for outputting a voice message to a passenger of the vehicle includes: a voice message information data obtaining element for obtaining voice message information data from at least one of an in-vehicle device and an external device, wherein the voice message information data represents a content of a voice message, and the in-vehicle device is mounted on the vehicle, and the external device is arranged on an outside of the vehicle; a number detector for detecting the number of the voice message information data, which is requested to be output simultaneously, based on the voice message information data; a voice message information processor for outputting voice message information annunciation data when the number of the voice message information data is equal to or larger than a predetermined number, the voice message information annunciation data having a message length, which is changed from a message length of the voice message information data; and an outputting element for outputting the voice message based on the voice message information annunciation data.

In the above device, when the voice message information data obtaining element, obtains multiple voice message information data that is required to be output simultaneously, the message length of the voice message information annunciation data is changed. Thus, the device provides a lot of information to a passenger of the vehicle in a short time.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a voice message outputting device;

FIG. 2 is a diagram showing the voice message outputting device mounted on a vehicle;

FIG. 3 is a flowchart showing a process for outputting a message;

FIG. 4 is a diagram showing a relationship between a code and voice message information data;

FIG. 5 is a diagram showing a determination condition of a message length;

FIG. 6 is a diagram showing a determination condition of the message length and an outputting speed of the message according to a second embodiment;

FIG. 7 is a flowchart showing a process for outputting a message according to a third embodiment;

FIG. 8 is a diagram showing a determination condition of the message length and the outputting speed of the message;

FIG. 9 is a diagram showing the determination condition of the message length and the outputting speed of the message; and

FIG. 10 is a block diagram showing a voice message outputting device with a wireless communication unit according to the third embodiment.

### DETAILED DESCRIPTION OF THE PREFERRED EMBODIMENTS

### First Embodiment

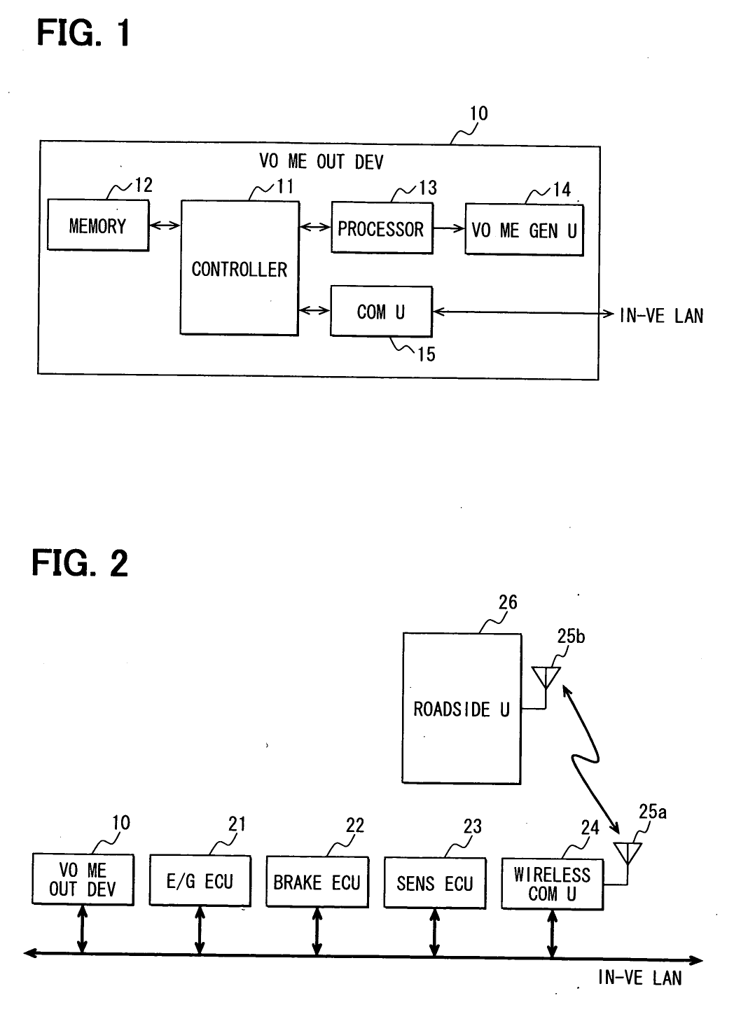

FIG. 1 shows a voice message outputting device 10 according to a first embodiment. The device 10 is mounted on a vehicle.

The device 10 includes a controller 11, a memory 12, a voice message information processor 13, a voice message generating unit 14 and a communication unit 15.

The controller 11 is a circuit for controlling a whole of the device 10. The controller 11 includes a microcomputer, a ROM, a RAM and a bus line, which couple between the microcomputer, the ROM and the RAM. The controller 11 is coupled with the memory 12, the voice message information processor 13, the communication unit 15 and the like. The memory 12 is a non-volatile memory means such as a flash memory. The memory 12 stores a voice message information data, acoustic model data and the like. The voice message information data is used for outputting a voice message information annunciation data from the voice message information processor 13. The acoustic model data represents a characteristic amount corresponding to a predetermined word and/or a paragraph including the predetermined word of the message. The voice message information processor 13 outputs the voice message information annunciation data having a short message length based on the voice message information data stored in the memory. The voice message generating unit 14 is coupled with the voice message information processor 13. The voice message generating unit 14 informs a voice message based on the voice message information annunciation data output from the voice message information processor 13. As shown in FIG. 2, the communication unit 15 is coupled with an engine ECU 21, a brake ECU 22, a sensor ECU 23 and a wireless communication unit 24 via an in-vehicle LAN. The engine ECU 21 detects information about an engine of the vehicle through the in-vehicle LAN. The brake ECU 22 detects information about a brake pedal so that a pressing amount of the brake pedal by the driver of the vehicle is obtained. The sensor ECU 23 controls a vehicle speed sensor for detecting a vehicle speed pulse, and a steering angle sensor for detecting a steering angle of a steering wheel of the vehicle. The wireless communication unit 24 communicates with an external device wirelessly.

The wireless communication unit 24 and an antenna 25a are connected to the in-vehicle LAN. The wireless communication unit 24 wirelessly communicates with a roadside unit 26 having an antenna 25b. The wireless communication between the roadside unit 26 and the wireless communication unit 24 is performed by a DSRC (dedicated short range communication) method.

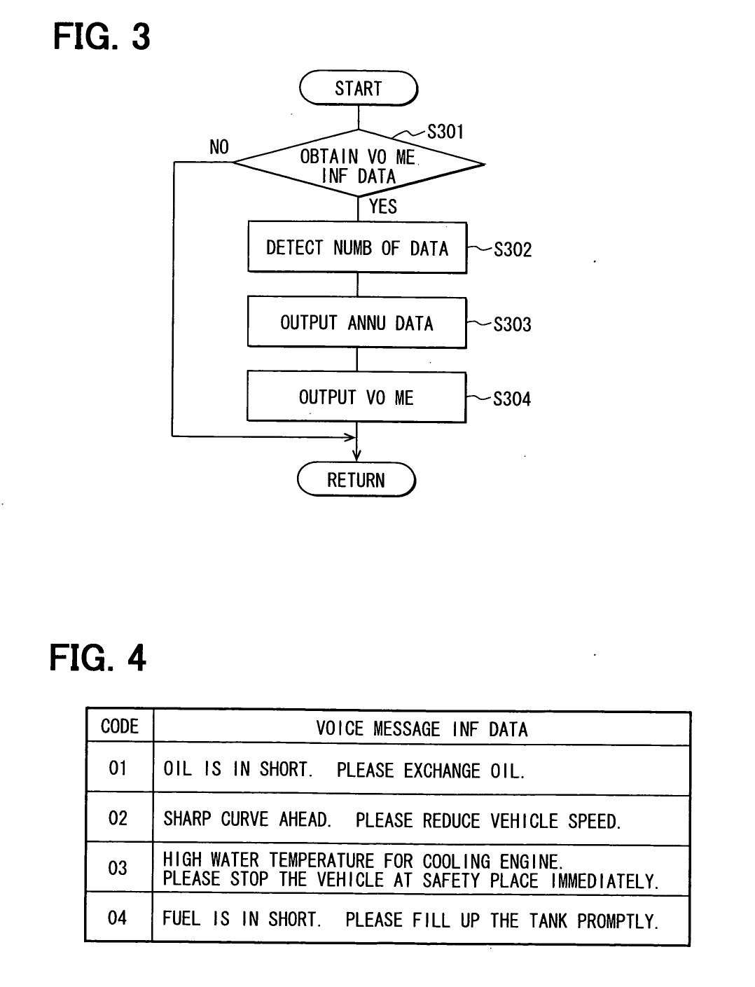

A process for outputting a message according to the present embodiment is shown in FIG. 3. The device 10 starts to execute this process when an ignition switch of the vehicle turns on.

First, the controller 11 obtains voice message information data in step S301. The controller 11 obtains the voice message information data from the in-vehicle device such as the engine ECU 21, the brake ECU 22 and the sensor ECU 23 through the in-vehicle LAN, which is connected to the communication unit 15. Then, the memory 12 stores the voice message information data of the in-vehicle device. When the vehicle enters a communication area of the roadside unit 26, the controller 11 obtains the voice message information data from the roadside unit 26 as an external device through the wireless communication unit 24. Then, the memory 12 stores the voice message information data of the external device. For example, the controller 11 obtains the voice message information data about water temperature of an engine and a condition of engine oil from the engine ECU 21. The controller 11 obtains the voice message information data about fee payment information of an automatic fee collection system from the roadside unit 26. Thus, the memory 12 preliminary stores multiple voice message information data. For example, as shown FIG. 4, the voice message information data corresponding to a code, which is received from the in-vehicle device, is obtained from the memory 12. The obtained voice message information data is text data for TTS (text to speech) or signal information of recorded voice messages. When the voice message information data is obtained, it goes to step S302. When the voice message information data is not obtained, it goes to step S301.

In step S302, the controller 11 detects the number of the voice message information data, which is obtained in step S301, and requested to inform at the same time.

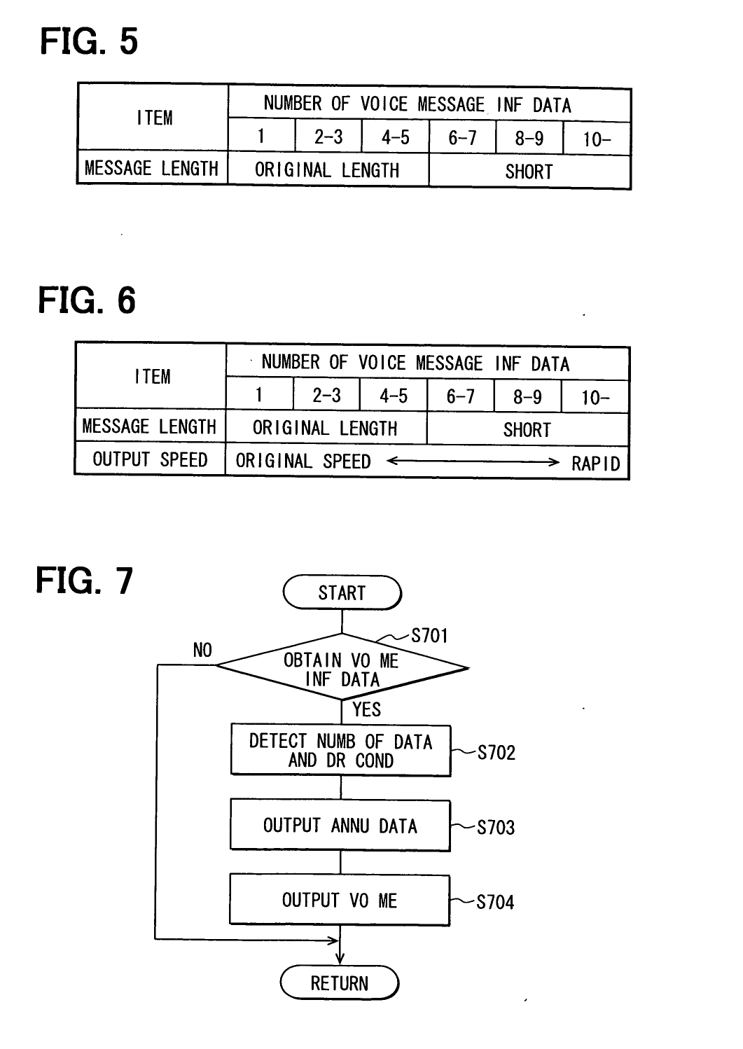

Next, in step S303, the voice message information processor 13 outputs the voice message information annunciation data based on the number of the voice message information data, which is detected in step S302. FIG. 5 shows an example of classification of the number of the voice message information data. In FIG. 5, the voice message information data is classified into six classes. In FIG. 5, when the number of the voice message information data is large, the voice message information processor 13 determines that it is necessary to provide a lot of information to the passenger of the vehicle in a short period of time. Then, a message length of the voice message information annunciation data is shortened. For example, when the message length is shortened, the voice message information annunciation data having the short message length such as “oil” is retrieved from the voice message information data such as “Oil is in short. Please exchange the oil.” Then, the short voice message information annunciation data of “oil” is output. Specifically, when the voice message information data is a text data, a word or a phrase including the word is retrieved from the text data. Thus, the voice message information annunciation data having the short message length such as “oil” or “Oil is in short” is retrieved. When the voice message information data is signal information of a recorded voice message, the voice message information processor 13 compares a characteristic amount retrieved from the signal information with a characteristic amount corresponding to the word or the phrase including the word stored in the memory 12. Then, the voice message information processor 13 outputs the voice message information annunciation data having the short message length. Further, a part of the voice message information data corresponding to the predetermined number of characters such as five characters from a top of the voice message information data is retrieved. Thus, the voice message information processor 13 outputs the voice message information annunciation data having the short message length. Further, an annunciation time period is preliminary set to be, for example, one second. A part of the voice message information data corresponding to the annunciation time period is retrieved. Thus, the voice message information processor 13 outputs the voice message information annunciation data having the short message length. Furthermore, when it is not necessary to reduce the message length since the number of the voice message information data, which is announced at the same time, is small, the voice message information annunciation data is output without changing the message length of the voice, message information data.

Next, in step S304, the voice message generating unit 14 outputs a voice message based on the voice message information annunciation data output from the voice message information processor 13. Then, it returns to step S301.

In the first embodiment, based on the number of the voice message information data, which is necessary to be informed at the same time, the message length of the voice message information annunciation data is determined. As a result, when multiple voice message information data are required to be announced at the same time, the message length of the voice message information annunciation data is shortened so that a lot of information is provided to the passenger of the vehicle in a short time.

### Second Embodiment

According to a second embodiment, when the voice message information annunciation data is output in step S303 in FIG. 3, an output speed of the voice message is determined based on the number of the voice message information data in addition to the determination of the message length of the voice message information annunciation data. In FIG. 6, when the number of the voice message information data is large, the voice message information processor 13 determines that it is necessary to provide a lot of information to the passenger in a short time. Then, the message length of the voice message information annunciation data is reduced, and further, the output speed of the voice message increases.

In the second embodiment, the message length and the output speed of the message in the voice message information annunciation data are determined based on the number of the voice message information data, which is necessary to be informed at the same time. As a result, when a lot of voice message information data are required to be announced to the passenger at the same time, the message length of the voice message information annunciation data is shortened, and the output speed of the voice message in the voice message information annunciation data is increased. Thus, a lot of information is provided to the passenger of the vehicle effectively in a short time.

### Third Embodiment

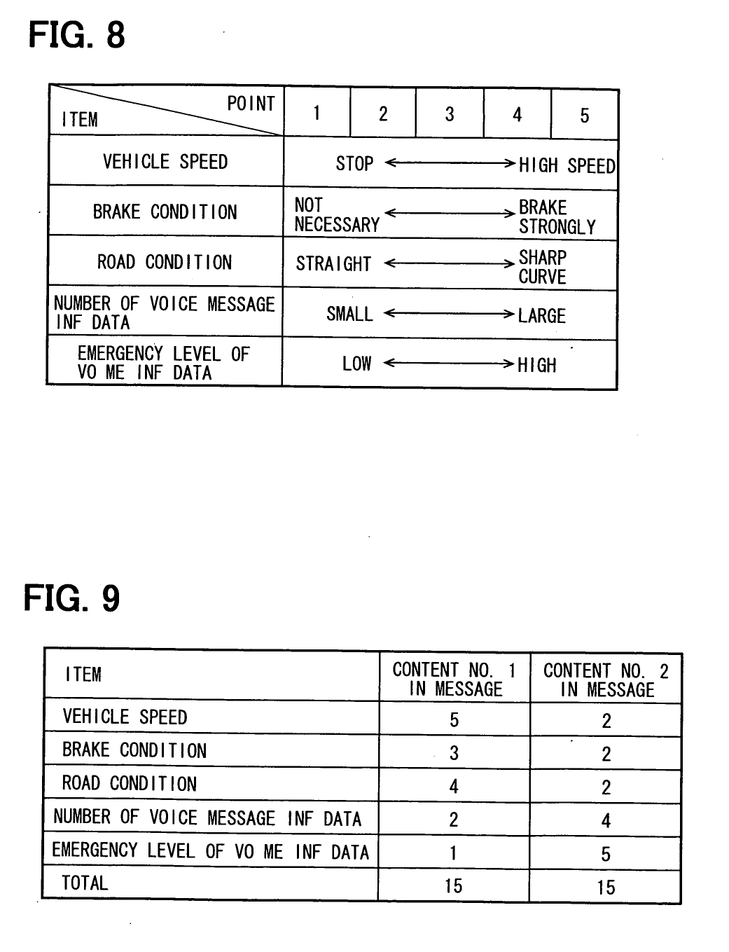

FIG. 7 shows a process for outputting a message according to a third embodiment, and FIG. 8 shows a determination condition of the message length and the outputting speed of the message. In the third embodiment, when the voice message information annunciation data is output based on the voice message information data, the message length and the output speed of the message are determined according to the emergency level of the voice message information data and the driving condition of the vehicle in addition to the number of the voice message information data, which is necessary to be informed simultaneously.

In FIG. 7, the controller 11 obtains the voice message information data in step S701 from the in-vehicle device.

Next, in step S702, the controller 11 detects the number of the voice message information data, which is necessary to be announced simultaneously, and further, the driving condition of the vehicle. Specifically, the vehicle speed of the vehicle is obtained according to a vehicle speed pulse signal detected by a vehicle speed sensor through the in-vehicle LAN, which is connected to the communication unit 15. The braking degree of a brake pedal of the vehicle applied by the driver is obtained from the brake ECU 22. Further, the road condition such as a road shape of a road, on which the vehicle runs at the present time, is obtained according to a driving path of the vehicle. The driving path is detected by a steering angle of the steering wheel detected by the steering angle sensor, the GPS and the acceleration sensor of the vehicle. The GPS is a global positioning system for detecting a current position of the vehicle.

In step S703, the voice message information processor 13 outputs the voice message information annunciation data according to the number of the voice message information data, which is necessary to be announced at the same time, the driving condition of the vehicle, and the emergency level of the voice message information data, which is provided by the voice message information data. For example, FIG. 8 shows an example of classification with five classes. Specifically, the vehicle speed, the brake condition, the road condition, the number of voice message information data and the emergency level of the voice message information data are classified into five classes, respectively. Each class has own point from one point to five points. When the total point of all items is large, the voice message information processor 13 determines that it is necessary to provide a lot of information to the passenger of the vehicle in a short time. Then, the message length of the voice message information annunciation data is shortened, and the output speed of the message is increased. In FIG. 8, regarding the vehicle speed, the brake condition and the road condition, which relate to the driving status of the vehicle, when the driving load of the driver is large, the point of each item is increased. Specifically, when the vehicle speed is high, it is necessary for the driver to concentrate the driving of the vehicle. Accordingly, when the vehicle speed is high, the driving load of the driver is large. Similarly, when the braking degree of the brake pedal is strong, the driver concentrates to drive the vehicle. Thus, the driving load is large. When the road shape of the road, on which the vehicle runs, is the sharp curve, the driver has to operate the steering wheel many times. Thus, the driving load of the driver is large. When the number of the voice message information data, which is required to be informed at the same time, is large, and when the emergency level of the voice message information data is high, it is necessary to announce the information as soon as possible. Thus, the point of each item is increased.

Next, the voice message generating unit 14 outputs the voice message according to the voice message information annunciation data output from the voice message information processor 13 and the output speed of the message. Then, it returns to step S701.

In the third embodiment, the message length of the voice message information annunciation, data and the output speed of the message are determined based on the emergency level of the voice message information data and the driving condition of the vehicle in addition to the number of the voice message information data, which is required to be informed at the same time. As a result, in view of the driving load of the driver, the message length of the voice message information annunciation data and the output speed of the message are determined so as to provide driving concentration for the driver.

### Other Embodiments

For example, in step S301 in FIG. 3, when the controller 11 obtains the voice message information data from the in-vehicle device or the external device, second voice message information data having a short message length may be obtained at the same time. Here, the second voice message information data represents the same content of the voice message information data. Then, the second voice message information data is stored in the memory 12.

Next, based on the number of the voice message information data obtained in step S302, the voice message information processor 13 may outputs the second voice message information data as the voice message information annunciation data when it is necessary to output the voice message information annunciation data having a short message length. Thus, although the voice message information processor 13 does not execute a process for retrieving the word from the voice message information data, the voice message information processor 13 can output the voice message information annunciation data having a short message length.

Further, in the third embodiment, even when the total points of the items are same, the message length and the output speed of the message may be differentiated based on the point of each item. For example, in FIG. 9, the total points of the content No. 1 in the message is the same as the total points of the content No 2 in the message. However, the number of the voice message information data in the content No. 2 is larger than the content No. 1, and further, the emergency level in the content No. 2 is higher than the content No. 1. Accordingly, the message length of the content No. 2 is shortened and the output speed of the message in the content No. 2 is increased, compared with the content No. 1.

In FIG. 2, the wireless unit 24 communicates with the roadside unit 26 wirelessly. Alternatively, the wireless unit 24 may wirelessly communicate with a base station via a wide area wireless communication system so that the voice message information data is obtained. Alternatively, the wireless unit 24 may be coupled with a cell phone in the vehicle so that the wireless unit 24 obtains the voice message information data such as an incoming call and an e-mail incoming call.

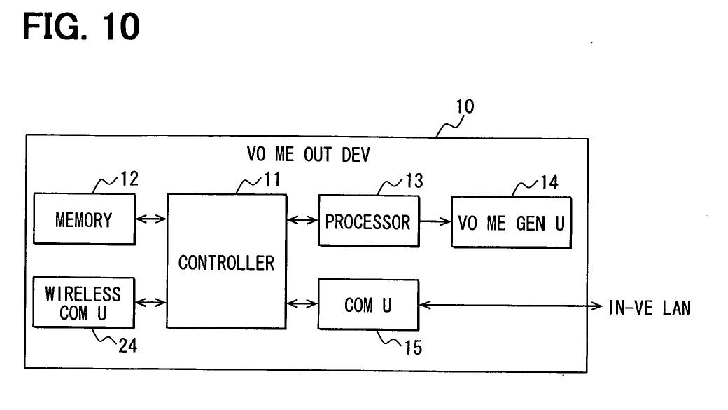

In FIG. 2, the wireless unit 24 is connected to the in-vehicle LAN. Alternatively, as shown in FIG. 10, the wireless unit 24 may be incorporated in the voice message outputting device 10.

The above disclosure has the following aspects.

According to an aspect of the present disclosure, a voice message outputting device mounted on a vehicle for outputting a voice message to a passenger of the vehicle includes: a voice message information data obtaining element for obtaining voice message information data from at least one of an in-vehicle device and an external device, wherein the voice message information data represents a content of a voice message, and the in-vehicle device is mounted on the vehicle, and the external device is arranged on an outside of the vehicle; a number detector for detecting the number of the voice message information data, which is requested to be output simultaneously, based on the voice message information data; a voice message information processor for outputting voice message information annunciation data when the number of the voice message information data is equal to or larger than a predetermined number, the voice message information annunciation data having a message length, which is changed from a message length of the voice message information data; and an outputting element for outputting the voice message based on the voice message information annunciation data.

In the above device, when the voice message information data obtaining element obtains multiple voice message information data that is required to be output simultaneously, the message length of the voice message information annunciation data is changed. Thus, the device provides a lot of information to a passenger of the vehicle in a short time.

Alternatively, the voice message information processor may shorten the message length of the voice message information annunciation data when the number of the voice message information data is large.

Alternatively, the voice message information processor may shorten the message length of the voice message information annunciation data in such a manner that a word or a phrase is retrieved from the voice message information data.

Alternatively, the voice message information processor may shorten the message length of the voice message information annunciation data in such a manner that a part of the voice message information data corresponding to a predetermined number of characters is retrieved.

Alternatively, the voice message information processor may shorten the message length of the voice message information annunciation data in such a manner that a part of the voice message information data corresponding to a predetermined outputting time period is retrieved.

Alternatively, the voice message information data may be a text data or signal information of a recorded voice message.

Alternatively, the voice message outputting device may further include: a memory. A table of the voice message information data is preliminary stored in the memory. Further, the voice message information data obtaining element may obtain a code from the at least one of the in-vehicle device and the external device, and the voice message information data obtaining element may check the code with the table so that the voice message information data obtaining element obtains the voice message information data.

Alternatively, the voice message information data obtaining element may obtain second voice message information data when the voice message information data obtaining element obtains the voice message information data. The second voice message information data has a message length, which is shorter than the message length of the voice message information data. The second voice message information data represents a content of a voice message, which means the same content as the voice message information data. The voice message information processor outputs the second voice message information data as the voice message information annunciation data when the number of the voice message information data is equal to or larger than the predetermined number.

Alternatively, the voice message information annunciation data may have an output speed of the voice message. The voice message information processor changes the output speed of the voice message information annunciation data from an output speed of the voice message information data when the number of the voice message information data is equal to or larger than the predetermined number.

Alternatively, the voice message information processor may change the message length of the voice message information annunciation data from the message length of the voice message information data based on both of the number of the voice message information data and a vehicle speed of the vehicle.

Alternatively, the voice message information processor may change the message length of the voice message information annunciation data from the message length of the voice message information data based on both of the number of the voice message information data and a road condition of a road, on which the vehicle runs.

Alternatively, the voice message information processor may change the message length of the voice message information annunciation data from the message length of the voice message information data based on both of the number of the voice message information data and a brake condition of the vehicle.

Alternatively, the voice message information processor may change the message length of the voice message information annunciation data from the message length of the voice message information data based on both of the number of the voice message information data and an emergency level of the voice message information data.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A voice message outputting device mounted on a vehicle for outputting a voice message to a passenger of the vehicle comprising:
a voice message information data obtaining element for obtaining voice message information data from at least one of an in-vehicle device and an external device, wherein the voice message information data represents a content of a voice message, and the in-vehicle device is mounted on the vehicle, and the external device is arranged on an outside of the vehicle;
a number detector for detecting the number of the voice message information data, which is requested to be output simultaneously, based on the voice message information data;
a voice message information processor for outputting voice message information annunciation data when the number of the voice message information data is equal to or larger than a predetermined, number, the voice message information annunciation data having a message length, which is changed from a message length of the voice message information data; and
an outputting element for outputting the voice message based on the voice message information annunciation data.

2. The voice message outputting device according to claim 1,
wherein the voice message information processor shortens the message length of the voice message information annunciation data when the number of the voice message information data is large.

3. The voice message outputting device according to claim 1,
wherein the voice message information processor shortens the message length of the voice message information annunciation data in such a manner that a word or a phrase is retrieved from the voice message information data.

4. The voice message outputting device according to claim 1,
wherein the voice message information processor shortens the message length of the voice message information annunciation data in such a manner that a part of the voice message information data corresponding to a predetermined number of characters is retrieved.

5. The voice message outputting device according to claim 1,
wherein the voice message information processor shortens the message length of the voice message information annunciation data in such a manner that a part of the voice message information data corresponding to a predetermined outputting time period is retrieved.

6. The voice message outputting device according to claim 1,
wherein the voice message information data is a text data or signal information of a recorded voice message.

7. The voice message outputting device according to claim 1, further comprising:
a memory;
wherein a table of the voice message information data is preliminary stored in the memory.

8. The voice message outputting device according to claim 7,
wherein the voice message information data obtaining element obtains a code from the at least one of the in-vehicle device and the external device, and
wherein the voice message information data obtaining element checks the code with the table so that the voice message information data obtaining element obtains the voice message information data.

9. The voice message outputting device according to claim 1,
wherein the voice message information data obtaining element obtains second voice message information data when the voice message information data obtaining element obtains the voice message information data,
wherein the second voice message information data has a message length, which is shorter than the message length of the voice message information data,
wherein the second voice message information data represents a content of a voice message, which means the same content as the voice message information data, and
wherein the voice message information processor outputs the second voice message information data as the voice message information annunciation data when the number of the voice message information data is equal to or larger than the predetermined number.

10. The voice message outputting device according to claim 1,
wherein the voice message information annunciation data has an output speed of the voice message, and
wherein the voice message information processor changes the output speed of the voice message information annunciation data from an output speed of the voice message information data when the number of the voice message information data is equal to or larger than the predetermined number.

11. The voice message outputting device according to claim 1,
wherein the voice message information processor changes the message length of the voice message information annunciation data from the message length of the voice message information data based on both of the number of the voice message information data and a vehicle speed of the vehicle.

12. The voice message outputting device according to claim 1,
wherein the voice message information processor changes the message length of the voice message information annunciation data from the message length of the voice message information data based on both of the number of the voice message information data and a road condition of a road, on which the vehicle runs.

13. The voice message outputting device according to claim 1,
wherein the voice message information processor changes the message length of the voice message information annunciation data from the message length of the voice message information data based on both of the number of the voice message information data and a brake condition of the vehicle.

14. The voice message outputting device according to claim 1,
wherein the voice message information processor changes the message length of the voice message information annunciation data from the message length of the voice message information data based on both of the number of the voice message information data and an emergency level of the voice message information data.
